(19) United States
(12) Patent Application Publication
(10) Pub. No.: US 2026/0260026 A1
(43) Pub. Date: Sep. 3, 2026

(54) PLACEMENT ASSISTANCE METHOD, PLACEMENT ASSISTANCE SYSTEM AND DATA CENTER

(71) Applicant: OBAYASHI CORPORATION, Tokyo (JP)

(72) Inventors: Akinori TSUNAWAKI, Tokyo (JP); Riki TABATA, Tokyo (JP); Hifumi IGUCHI, Tokyo (JP); Koichi NAKATSUKA, Tokyo (JP); Kazukiyo NUMATA, Tokyo (JP)

(73) Assignee: OBAYASHI CORPORATION, Tokyo (JP)

(21) Appl. No.: 18/841,984

(22) PCT Filed: Feb. 28, 2023
(86) PCT No.: PCT/JP2023/007326

§ 371 Date: Aug. 27, 2024

(30) Foreign Application Priority Data
Mar. 1, 2022 (JP) 2022 031018

(51) Int. Cl. G06F 30/13; G06F 113/02

(52) U.S. Cl. CPC G06F 30/13; G06F 2113/02

(57) ABSTRACT

A method of assisting determination of placement of servers includes identifying a total rated power of multiple servers installed at one level of a building; predicting a total weight of the servers in accordance with the total rated power; distributing the total weight to the servers in accordance with a server composition ratio to classify the servers into first servers and second servers, the second servers each having a smaller weight than that of each first server; identifying locations of multiple beams supporting a floor surface of the level; placing each of the first servers directly above each of the beams; and placing each of the second servers between the first servers that are adjacent to each other.

### TECHNICAL FIELD

The present disclosure relates to a placement assistance method for assisting in the construction of a data center, a placement assistance system, and a data center.

### BACKGROUND ART

A data center draws large amounts of power and communications into the premises. Accordingly, a data center has a large area for arranging many servers. Each server is housed in a server rack. However, due to the increasing density of servers, the weight of servers per rack tends to increase. Consequently, the seismic performance required for buildings also increases. Furthermore, each server generates heat by consuming a significant amount of power, necessitating considerations for the internal structure of the data center, such as air conditioning. As a result, technologies for constructing data centers using the hot aisle/cold aisle configuration are being explored (see, for example, Patent Literature 1).

Furthermore, building structures for data centers are also being considered (see, for example, Patent Literature 2). In the technology disclosed in this document, the building structure includes beams that connect first pillars of the building, and truss beams that connect second pillars within the building, which are placed at spans longer than the spans of the first pillars. An external air intake section is provided in a chimney located outside the first pillars of the building to bring in cool air from the outside.

### CITATION LIST

### Patent Literature

Patent Literature 1: Japanese Laid-Open Patent Publication No. 2014-48027
Patent Literature 2: Japanese Laid-Open Patent Publication No. 2018-162626

### SUMMARY OF INVENTION

### Technical Problem

Due to closure and other issues related to the aging of existing data center facilities, there is a shortage of urban-type data centers in urban areas. However, in urban areas, securing construction sites for building large-scale data centers poses a challenge. Furthermore, making excessive capital investments to support the load capacity of servers used in data centers imposes a significant economic burden.

Therefore, it is necessary to construct data centers efficiently.

### Solution to Problem

In one general aspect, a placement assistance method includes: identifying a total rated power of multiple servers installed at one level of a building; predicting a total weight of the servers in accordance with the total rated power; distributing the total weight to the servers in accordance with a server composition ratio to classify the servers into first servers and second servers, the second servers each having a smaller weight than that of each first server; identifying locations of multiple beams supporting a floor surface of the level; placing each of the first servers directly above each of the beams; and placing each of the second servers between the first servers that are adjacent to each other.

In another general aspect, a placement assistance system includes a control unit that assists in determination of placement of servers. The control unit is configured to execute:
identifying a total rated power of multiple servers installed at one level of a building;
predicting a total weight of the servers in accordance with the total rated power; distributing the total weight to the servers in accordance with a server composition ratio to classify the servers into first servers and second servers, the second servers each having a smaller weight than that of each first server; identifying locations of multiple beams supporting a floor surface of the level; and generating a layout in which each of the first servers is placed directly above each of the beams, and each of the second servers is placed between the first servers that are adjacent to each other.

In a further general aspect, a data center includes multiple servers and multiple beams. The multiple servers are installed at one level of a building. The servers include first servers and second servers. The second servers each have a smaller weight than that of each first server. The multiple beams support a floor surface of the level. A composition ratio of the first servers and the second servers in the multiple servers is based on a total weight corresponding to a total rated power of the multiple servers, the first weight, and the second weight. Each of the first servers is placed directly above each of the beams. Each of the second servers is placed between the first servers that are adjacent to each other.

### BRIEF DESCRIPTION OF DRAWINGS

FIG. 1 is an explanatory diagram illustrating a placement assistance system according to one embodiment.

FIG. 2 is an explanatory diagram illustrating a hardware configuration according to the embodiment shown in FIG. 1.

FIG. 3 is an explanatory diagram illustrating a placement assistance method according to the embodiment shown in FIG. 1.

FIG. 4A is an explanatory diagram of server placement according to the embodiment shown in FIG. 1, illustrating the configuration of a data center.

FIG. 4B is an explanatory diagram of the server placement according to the embodiment shown in FIG. 1, illustrating the classification of server racks.

FIG. 4C is an explanatory diagram of the server placement according to the embodiment shown in FIG. 1, illustrating the layout of the server racks.

### DESCRIPTION OF EMBODIMENTS

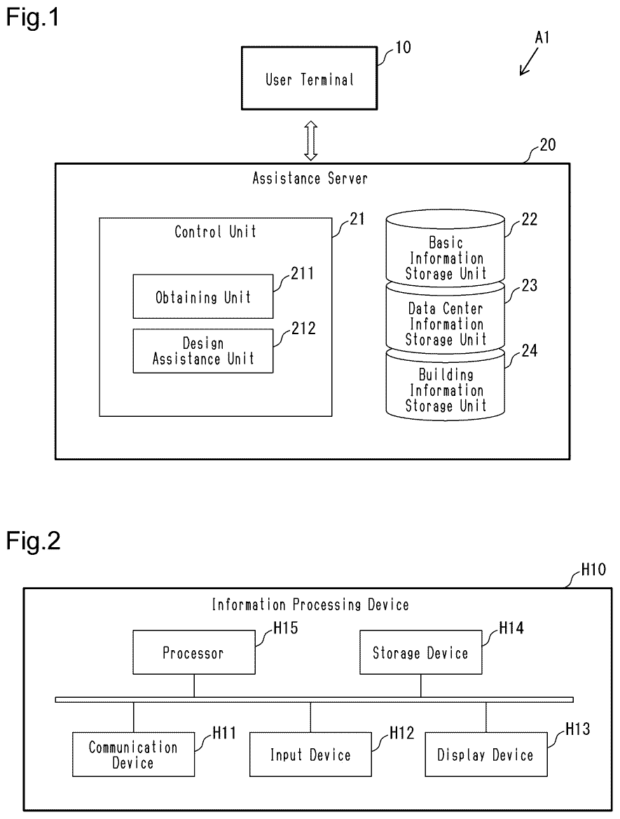

A placement assistance method according to one embodiment will now be described with reference to FIGS. 1 to 4C. In the present embodiment, multiple existing office buildings are renovated to construct a group of small-scale data centers. These data center groups are then connected via dedicated lines to create a virtual large-scale data center. The placement assistance method, placement assistance system, and data centers used in this case will be explained.

In the present embodiment, as shown in FIG. 1, a placement assistance system A1 utilizes a user terminal 10 and an assistance server 20, which are interconnected via a network.

### Description of Hardware Configuration

A hardware configuration of an information processing device H10, which functions as the user terminal 10 and the assistance server 20, will be described with reference to FIG. 2. The information processing device H10 includes a communication device H11, an input device H12, a display device H13, a storage device H14, and a processor H15. This hardware configuration is merely an example, and the information processing device H10 may be implemented by other hardware.

The communication device H11 is an interface that establishes communication paths with other devices so as to transmit and receive data. The communication device H11 is, for example, a network interface or a wireless interface.

The input device H12 receives input of various types of information, and is, for example, a mouse or a keyboard. The display device H13 is, for example, a display that displays various types of information. A touch screen may be used as the input device H12 and the display device H13.

The storage device H14 stores data and various programs used to perform various functions of the user terminal 10 and the assistance server 20. Examples of the storage device H14 include a read-only memory (ROM), a random-access memory (RAM), and a hard disk drive.

The processor H15 uses programs and data stored in the storage device H14 to control processes in the user terminal 10 and the assistance server 20. Examples of the processor H15 include, for example, a central processing unit (CPU) and a micro processor unit (MPU). The processor H15 expands, in RAM, programs stored in ROM or the like, so as to execute various processes.

The processor H15 is not limited to one that performs software processing on all processes executed by itself. For example, the processor H15 may include a dedicated hardware circuit (for example, an application specific integrated circuit: ASIC) that executes at least part of the processes executed by itself. Specifically, the processor H15 may be any of the following.
[1] One or more processors that operate according to a computer program (software).
[2] One or more dedicated hardware circuits that execute at least part of various in processes.
[3] Circuitry including a combination of the above elements.

A processor includes a CPU and a memory, such as a RAM and a ROM, and the memory stores program codes or instructions configured to cause the CPU to execute processes. Memory or computer-readable media includes any available media that can be accessed by a general purpose or special purpose computer.

### System Configuration

Next, functions of the placement assistance system A1 will be described with reference to FIG. 1.

The user terminal 10 is a computer terminal used by a designer who decides the placement of servers. The designer accesses the assistance server 20 using the user terminal 10.

The assistance server 20 is a computer system that executes processes to assist in server placement design. The assistance server 20 includes a control unit 21, a basic information storage unit 22, a data center information storage unit 23, and a building information storage unit 24.

The control unit 21 executes processes discussed below (processes including an obtainment stage and a design assistance stage). By executing processing programs for this purpose, the control unit 21 functions as an obtaining unit 211, a design assistance unit 212, and the like.

The obtaining unit 211 obtains various types of information from the user terminal 10.

The design assistance unit 212 assists in the design of a data center in which servers are placed in an existing building. It is also possible to use the building information modeling (BIM).

The basic information storage unit 22 stores information for assisting in placement of servers. In the present embodiment, the basic information storage unit 22 stores weight calculation information and server composition information.

The weight calculation information is information for calculating a total weight from a total rated power. In the present embodiment, a table in which the total weight of the servers is stored for each capacity range of the total rated power is used as the weight calculation information.

The server composition information is the information for calculating a composition ratio of multiple types of server racks having different weights (server composition ratio). For example, a case will now be considered in which high-density servers, medium-density servers, and low-density servers are used as server racks. The weight of a medium-density server is lighter than that of a high-density server, and the weight of a low-density server is even lighter than that of the medium-density server. In the present embodiment, a high-density server, which has a relatively heavy weight, functions as a first server, while a medium-density server and a low-density server, both of which have relatively light weights, function as second servers. In this case, a table that stores the composition ratio (n1:n2:n3) corresponding to the type of server rack (high-density server, medium-density server, low-density server) is used as the server composition information for a data center.

The data center information storage unit 23 stores data center management information related to a data center to be constructed. The data center management information includes information regarding a center identifier, a building identifier, total rated power for each level of the building, and the number of servers.

The center identifier is an identifier used to identify the data center to be constructed.

The building identifier is an identifier used to identify the building in which the data center is to be constructed. In the present embodiment, an existing building is used as the building in which the data center is to be constructed.

The level refers to the story in the existing building where the servers are to be placed.

The total rated power is the sum of the power ratings of the servers to be placed on this level.

The number of servers refers to the quantity of servers to be placed in this level.

The building information storage unit 24 stores building management information concerning the building that is to be renovated into the data center. When a building in which the data center is to be constructed is registered, the building information storage unit 24 stores the building management information. The building management information includes the building identifier and the design drawings for the respective levels of the building.

The building identifier is used to identify the existing building in which the data center is to be constructed.

The design drawings record the arrangements and sizes of the structural components of the building (the foundation, the pillars, the beams, the floor surfaces, the walls, and the like). By utilizing the design drawings, it is possible to calculate the load capacity of each level.

### Design Process

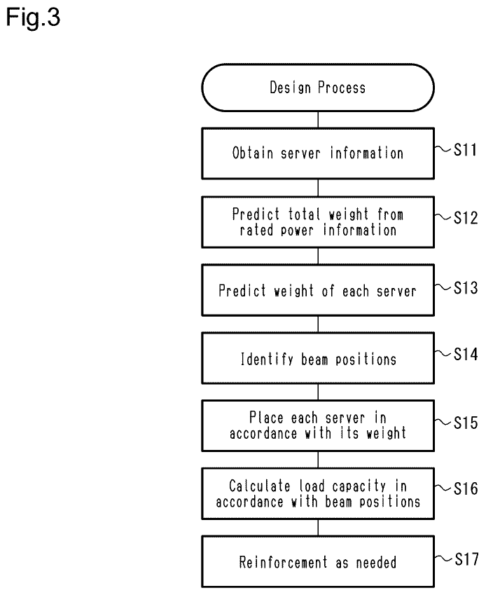

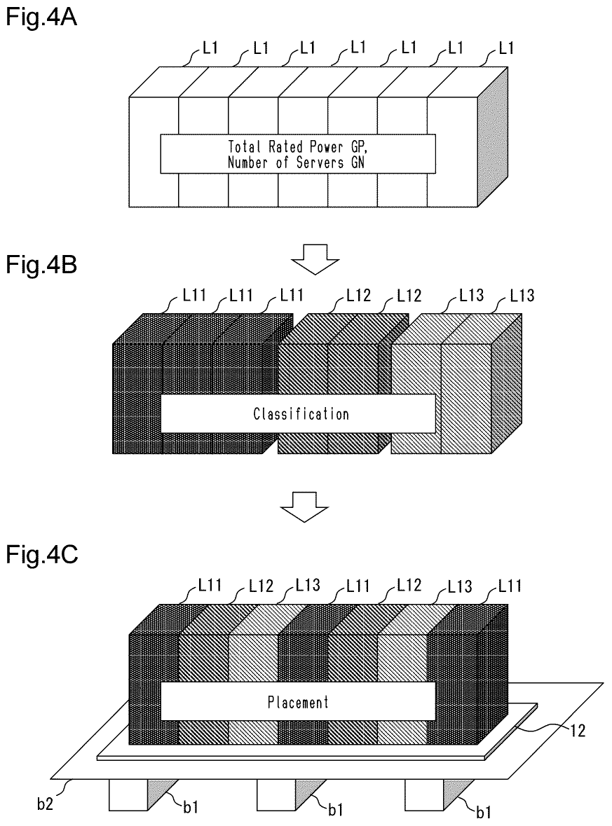

Next, a design process will be described with reference to FIGS. 3 and 4A to 4C.

First, the control unit 21 of the assistance server 20 executes a process of obtaining server information (Step S11). Specifically, the obtaining unit 211 of the control unit 21 obtains the server information from the user terminal 10.

In the present embodiment, as shown in FIG. 4A, a total rated power GP of a set of servers housed in server racks L1 installed on one level, and the number of servers GN are obtained as server information.

Next, the control unit 21 executes a process of predicting the total weight from the rated power information (step S12). Specifically, the design assistance unit 212 of the control unit 21 predicts a total weight WT of the server set from the total rated power GP, using the weight calculation information stored in the basic information storage unit 22.

Next, the control unit 21 executes a process of predicting the weight of each server (step S13). Specifically, the design assistance unit 212 acquires the composition ratio corresponding to the types of server racks from the server composition information stored in the basic information storage unit 22.

As shown in FIG. 4B, the composition ratio (Rn1:Rn2:Rn3) of the high-density servers L11, the medium-density servers L12, and the low-density servers L13, which are server racks, is acquired. In this case, the following equations are satisfied.

$$x 1 : x 2 : x 3 = Rn 1 : Rn 2 : Rn 3$$

$$x 1 + x 2 + x 3 = G N$$

As a result, the number of high-density servers, medium-density servers, and low-density servers (x1, x2, and x3) can be calculated.

Next, the design assistance unit 212 acquires a weight ratio (Rw1:Rw2:Rw3) of one high-density server L11, one medium-density server L12, and one low-density server L13 from the server composition information stored in the basic information storage unit 22. In this case, the following equations are satisfied.

$$W 1 : W 2 : W 3 : = Rw 1 : Rw 2 : Rw 3$$

$$W 1 \cdot x 1 + W 2 \cdot x 2 + W 3 \cdot x 3 = WT$$

By solving these equations, the weights (W1, W2, W3) of the high-density server L11, the medium-density server L12, and the low-density server L13 are calculated.

Next, the control unit 21 executes a process of identifying the positions of beams (step S14). Specifically, the design assistance unit 212 acquires the structure information of the building from the building information storage unit 24. The design assistance unit 212 displays the structure information of the building on the display device H13 of the user terminal 10. In this case, the designer specifies the level on which the data center is to be constructed. In this case, the design assistance unit 212 identifies the positions of primary beams and secondary beams that support the floor surface of the specified level in the structure information.

Next, the control unit 21 executes a server placement process in accordance with the weights of the servers (step S15). Specifically, the design assistance unit 212 places each high-density server on a part of the floor surface that is directly above a beam. In this example, the number of the high-density servers is less than or equal to the number of the beams. Then, the design assistance unit 212 generates a layout of server placement in which a medium-density server L12 and a low-density server L13 are placed between high-density servers L11 adjacent to each other. In this process, the standardized size of a server rack (for instance, a width of 19 inches) is used. The intervals between the servers are adjusted and the servers are rearranged such that a medium-density server L12 and a low-density server L13 are placed between adjacent high-density servers L11, and the high-density servers L11 overlap sections directly above beams.

Next, the control unit 21 executes a process of calculating the load capacity in accordance with the positions of the beams (step S16). Specifically, the design assistance unit 212 calculates the load capacity necessary for the floor surface when the weights of the high-density servers, the medium-density servers, and the low-density servers are transmitted to the respective beams, in accordance with the weights and placement of the servers.

Next, the control unit 21 performs a reinforcement process as needed (step S17). Specifically, the design assistance unit 212 obtains the permissible load of the floor surface in the existing building in accordance with the structure information of the building stored in the building information storage unit 24. Then, the design assistance unit 212 compares the calculated load capacity with the permissible load. When the load capacity exceeds the permissible load, the design assistance unit 212 outputs a proposal for floor surface reinforcement.

As shown in FIG. 4C, a slab 12, which spans the beams b1, can be used for the reinforcement of the parts of the floor surface b2 between the beams b1.

Then, the data center is constructed in the existing building according to the placement of the high-density servers, the medium-density servers, and the low-density servers determined by the design process. In this case, various servers used at the data center are classified into high-density servers, medium-density servers, and low-density servers according to their types. These servers are then arranged in accordance with the layout of the high-density servers, the medium-density servers, and the low-density servers.

The present embodiment has the following advantages.

(1) In the present embodiment, the control unit 21 executes the process of predicting the total weight from the rated power information (step S12). In this case, the weight calculation information stored in the basic information storage unit 22 is used. The weight of a server rack increases in accordance with its rated power. Thus, the weight calculation information can be used to predict the total weight of a set of servers used in a data center from the total rated power of the servers.

(2) In the present embodiment, the control unit 21 executes the process of predicting the weight of each server (step S13). In this case, the server composition information stored in the basic information storage unit 22 is used. The types of servers used in data centers are fairly consistent. Therefore, the composition ratio of the types of servers to be placed in the data center can also be statistically determined within a specified range. It is thus possible to predict the weights of servers, ranging from heavy, high-density servers to lightweight, low-density servers, by using the server composition information.

(3) In the present embodiment, the control unit 21 executes the process of identifying the positions of the beams (step S14), and the server placement process in accordance with the weight of each server (step S15). Accordingly, the heavy servers are placed on the beams, so that the load capacity is ensured. On the other hand, the load is dispersed by placing lightweight servers between the beams.

(4) In the present embodiment, the control unit 21 executes the process of calculating the load capacity in accordance with the positions of the beams (step S16), and executes the reinforcement process as necessary (step S17). It is thus possible to determine the necessity of reinforcement in consideration of the load capacity of the level by the server racks placed according to the types of the servers.

The above-described embodiment may be modified as follows. The above-described embodiment and the following modifications can be combined as long as the combined modifications remain technically consistent with each other.

In the above-described embodiment, the placement assistance method is executed using the user terminal 10 and the assistance server 20. The steps S11 to S17 may be performed manually.

In the above-described embodiment, multiple second servers are arranged between adjacent first servers. In FIG. 4C, two second servers (medium-density server L12 and low-density server L13) are placed between adjacent first servers (high-density servers L11). If the second servers can be positioned between the first servers, the number of second servers placed between the first servers is not limited.

In the above-described embodiment, the high-density server, the medium-density server, and the low-density server are types of the server racks, but the types are not limited to these three. Two types of server racks or four or more types of server racks may be used. In this case, the weight calculation information and the server composition information corresponding to the types are stored in the basic information storage unit 22. One or more of light-weight second servers are placed between heavy-weight first servers.

In the above-described embodiment, the user terminal 10 and the assistance server 20 are used. The hardware configuration is not limited to this. For instance, the user terminal 10 may include the control unit 21, the basic information storage unit 22, the data center information storage unit 23, and the building information storage unit 24, so that the design process is performed in the user terminal 10.

In the above-described embodiment, the data center is constructed in an existing building. The present disclosure may be applied to the placement of servers when a data center is constructed in a part of a newly constructed building.

In the above-described embodiment, the control unit 21 executes the server placement process in accordance with the weights of the servers (step S15). The load capacity distribution (load capacity map) of the level in which the servers are installed may be calculated by structural calculation of the building. Then, by using the load capacity map, the high-density servers are preferentially arranged in regions having a high load capacity, and the medium-density servers and the low-density servers are distributed to regions having a low load capacity. The load capacity map is used to execute the process of calculating the load capacity in accordance with the positions of the beams (step S16), and the reinforcement process as necessary (step S17). In addition, the control unit 21 may calculate the required minimum reinforcement and layout with respect to the total weight by repeating the server placement process (step S15) to the reinforcement process (step S17).

In the above-described embodiment, the control unit 21 executes the process of predicting the weight of each server (step S13). When the weights of the high-density server, the medium-density server, and the low-density server can be predicted, the number of servers of each type may be calculated from the total weight WT and the server composition ratio. For example, high-density servers, medium-density servers, and low-density servers that have weights (W1, W2, and W3) may be used in respective numbers (x1, x2, and x3).

$$x 1 : x 2 : x 3 = Rn 1 : Rn 2 : Rn 3$$

$$W 1 \cdot x 1 + W 2 \cdot x 2 + W 3 \cdot x 3 = WT$$

In this case, the numbers of servers (x1, x2, x3) are calculated by the following equations.

$$x 1 = α \cdot Rn 1$$

$$x 2 = α \cdot Rn 2$$

$$x 3 = α \cdot Rn 3$$

$$α = WT / ( W 1 \cdot Rn 1 + W 2 \cdot Rn 2 + W 3 \cdot Rn 3 )$$

The fractional parts of the numbers of the respective servers (x1, x2, x3) are rounded down.

By this method, when the weights of the heavy first servers and the light second servers can be estimated, the number of each type of servers can be calculated from the total weight WT and the server composition ratio. Then, for these numbers of the servers, the second servers are arranged between the adjacent first servers, achieving a layout that takes into consideration the load capacity.

1. A placement assistance method of assisting determination of placement of servers, comprising:
identifying a total rated power of multiple servers installed at one level of a building;
predicting a total weight of the servers in accordance with the total rated power;
distributing the total weight to the servers in accordance with a server composition ratio to classify the servers into first servers and second servers, the second servers each having a smaller weight than that of each first server;
identifying locations of multiple beams supporting a floor surface of the level;
placing each of the first servers directly above each of the beams; and
placing each of the second servers between the first servers that are adjacent to each other.

2. The placement assistance method according to claim 1, further comprising reinforcing the floor surface in accordance with a load capacity of the building by providing a slab spanning the beams.

3. A placement assistance system, comprising circuitry that assists in determination of placement of servers, wherein the circuitry is configured to execute: identifying a total rated power of multiple servers installed at one level of a building;
predicting a total weight of the servers in accordance with the total rated power;
distributing the total weight to the servers in accordance with a server composition ratio to classify the servers into first servers and second servers, the second servers each having a smaller weight than that of each first server;
identifying locations of multiple beams supporting a floor surface of the level; and
generating a layout in which each of the first servers is placed directly above each of the beams, and each of the second servers is placed between the first servers that are adjacent to each other.

4. A data center, comprising:
multiple servers installed at one level of a building, the servers including first servers and second servers, and the second servers each having a smaller weight than that of each first server; and
multiple beams supporting a floor surface of the level, wherein
a composition ratio of the first servers and the second servers in the multiple servers is based on a total weight corresponding to a total rated power of the multiple servers, the first weight, and the second weight,
each of the first servers is placed directly above each of the beams, and
each of the second servers is placed between the first servers that are adjacent to each other.

5. The data center according to claim 4, further comprising a slab that spans the beams to reinforce the floor surface in accordance with a load capacity of the building.
